(19) United States
(12) Patent Application Publication
(10) Pub. No.: US 2020/0304375 A1
(43) Pub. Date: Sep. 24, 2020

(54) GENERATION OF DIGITAL TWINS OF PHYSICAL ENVIRONMENTS

(71) Applicant: Microsoft Technology Licensing, LLC, Redmond, WA (US)

(72) Inventors: Selvi S. CHENNAI, Issaquah, WA (US); Matthew Evan VOGEL, Seattle, WA (US); Michelle Lynn BROOK, Redmond, WA (US); William Douglas GUYMAN, Seattle, WA (US)

(73) Assignee: Microsoft Technology Licensing, LLC, Redmond, WA (US)

(21) Appl. No.: 16/358,035

(22) Filed: Mar. 19, 2019

(51) Int. Cl. H04L 12/24; G06T 7/50; G06T 17/05; G06K 9/00; G06T 7/70; G02B 27/01

(52) U.S. Cl. CPC H04L 41/12; G06T 7/50; G06T 17/05; G06K 9/00664; G02B 2027/0138; G02B 27/0172; G06T 2207/10028; G06T 2207/10024; G06T 7/70

(57) ABSTRACT

A method is disclosed for generating a digital twin of a physical environment. Depth data for the physical environment is received from a depth sensing device. A three-dimensional map of the physical environment is then generated based at least on the received depth data, and a digital twin of the physical environment is then generated based on the generated three-dimensional map. Information is received regarding the location of one or more networked devices within the generated three-dimensional map. Each of the one or more networked devices is associated with a digital twin of the networked device. Coordinate locations are established in the generated three-dimensional map for each networked device. Each established coordinate location is associated with a device identity.

### BACKGROUND

An increasing number of devices are capable of uploading and/or receiving data over a network. For example, a building or campus may have a significant number of such devices that form a system known as an Internet of Things (IoT). Significant amounts of data may be generated among these networked devices. When parsed, this data may be used for device automation, data capture, providing alerts, personalization of settings, and numerous other applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

One example provides method for generating a digital twin of a physical environment. Depth data for the physical environment is received from a depth sensing device. A three-dimensional map of the physical environment is generated based at least on the received depth data, and a digital twin of the physical environment is generated based on the generated three-dimensional map. Information is received regarding the location of one or more networked devices within the generated three-dimensional map. Each of the one or more networked devices is associated with a digital twin of the networked device. Coordinate locations are established in the generated three-dimensional map for each networked device, and each established coordinate location is associated with a device identity.

### BRIEF DESCRIPTION OF THE DRAWINGS

FIG. 1 schematically shows an example multi-room building.

FIG. 2 shows a schematic diagram of an example cloud-based service for integrated management of a plurality of networked devices.

FIG. 3 shows an example method for generating a digital twin of a physical environment.

FIG. 4A shows an illustration of an example physical environment as seen through a head-mounted display.

FIG. 4B shows an illustration of an example partial digital reconstruction of the physical environment of FIG. 4A as seen through a head-mounted display.

FIG. 4C shows an illustration of an example total three- dimensional digital reconstruction of the physical environment of FIG. 4A.

FIG. 4D shows an illustration of an example of a two- dimensional projection of the three-dimensional digital reconstruction of FIG. 4C.

FIG. 5 shows an example topological map for a multi-campus company.

FIG. 6 shows an illustration of an updated physical environment of FIG. 4A as seen through a head-mounted display.

FIG. 7 shows an example method for retrieving device information.

FIG. 8 shows an illustration of a user retrieving device information via a head-mounted display.

FIG. 9 shows a schematic view of a head-mounted display device according to an example of the present disclosure.

FIG. 10 shows a schematic view of an example computing environment in which the methods of FIGS. 3 and 7 may be enacted.

### DETAILED DESCRIPTION

A digital twin may be conceptualized as a live, digital replica of a space, person, process or physical object. Two-way communication between cloud services and networked IoT devices of the digital twin may be established in order to monitor physical objects within the physical environment, manage data streams from IoT devices, and to keep the digital twin up to date. However, typical approaches to IoT solutions, wherein a plurality of devices are networked and the uploaded data streams from the devices are monitored, may be insufficient to provide user-friendly management solutions.

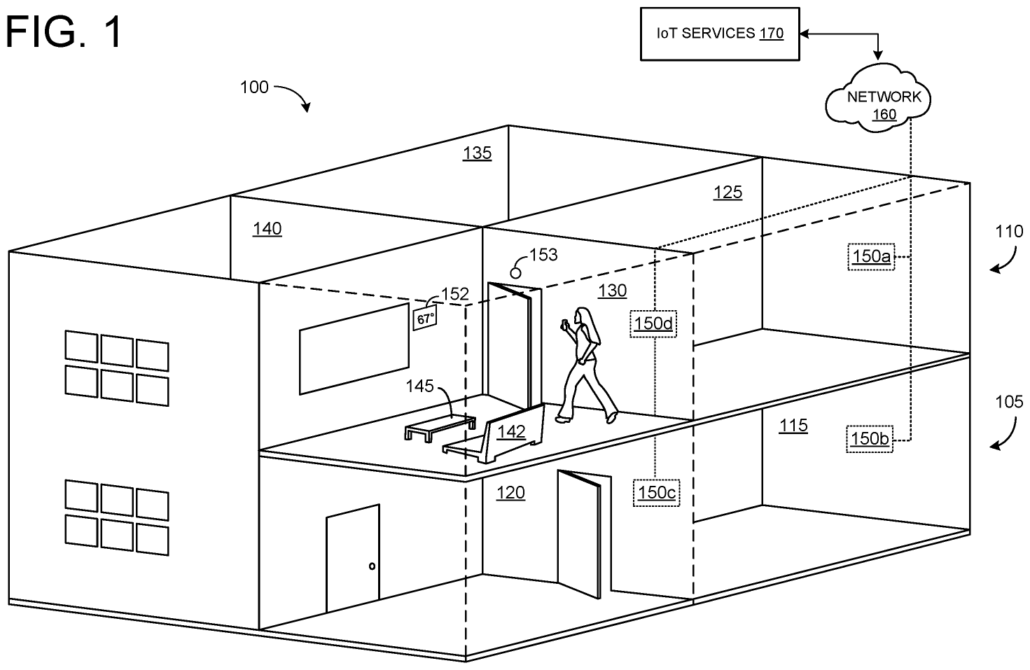

Facilities managers charged with managing a smart building (for occupancy information, security, energy reduction, predictive maintenance, etc.) may consider their building layout spatially. For example, FIG. 1 schematically shows an example multi-roomed building 100. Building 100 includes floors 105 and 110. Floor 105 includes at least rooms 115 and 120, and floor 110 includes at least rooms 125, 130, 135, and 140. Each room may include multiple passive objects (e.g., couch 142 and table 145) and multiple networked IoT devices (e.g., 150a, 150b, 150c, and 150d) that provide information about the state of the building and enable remote control of actuators. For example, networked IoT devices 150a, 150b, 150c, and 150d may include thermostats (e.g., thermostat 152), motion sensors (e.g., motion sensor 153), humidity sensors, etc. Networked IoT devices 150a-150d may be communicatively coupled to one or more networks 160, and may upload sensor data to one or more cloud services, such as IoT services 170 for storage and analysis.

In order to manage data acquired throughout a building such as building 100, a digital twin may be constructed for the building to model the building, its properties, the objects in it, and how devices and sensors as well as people relate to it.

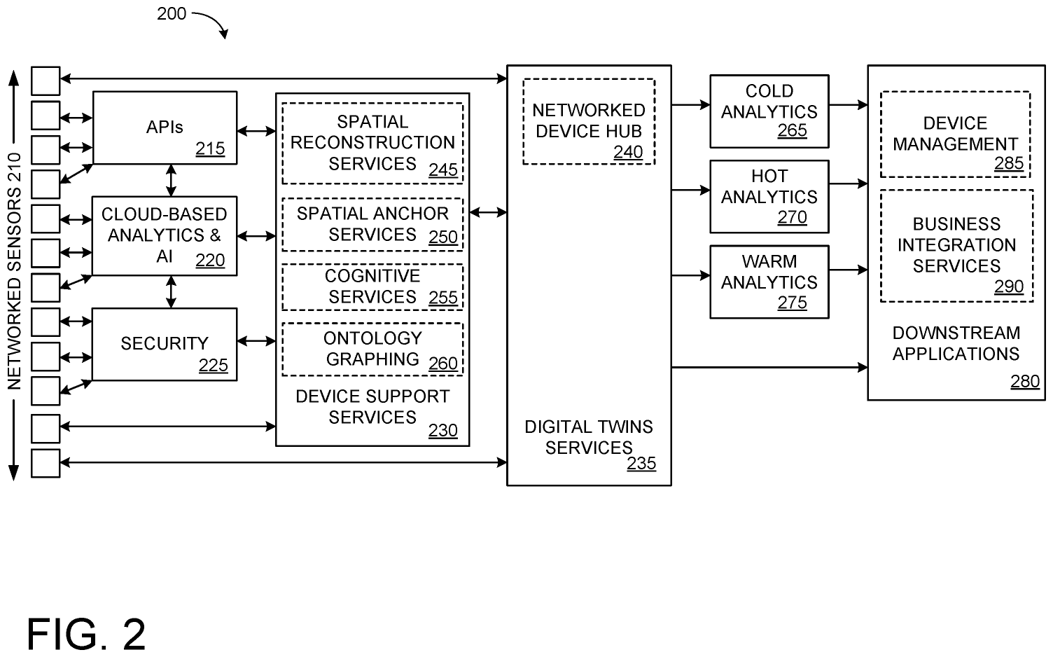

FIG. 2 shows a schematic diagram of a cloud-based service 200 for integrated management of a plurality of networked devices 210. Each networked device 210 may, individually or as part of a group, upload data to and receive information from a number of cloud-based applications. For example, the networked devices 210 may be connected to one or more Application Programming Interfaces (APIs) 215, analytics and artificial intelligence services 220, security services 225, device support services 230, and digital twins services 235. Each of APIs 215, analytics and AI services 220, security services 225, device support services 230, and digital twins services 235 may share data bi-directionally. Although each networked device is depicted as communicating with one hub or service, each networked device may communicate with two or more or all of the hubs and services shown. In some examples, one or more networked devices 210 may be communicatively coupled to a gateway, rather than directly to a network.

Digital twins services 235 may include networked device hub 240. Networked device hub 240 may enable bi-directional device-cloud communication, telemetry ingestion, device registration and identity services, device provisioning, management, etc. Digital twins services 235 may further enable a digital twins platform-as-a-service (PaaS), that may include a digital twins creation app, portions of which may be either operated locally or in the cloud.

Device support services 230 may include a plurality of services for generating, maintaining, and providing data to digital twins services 235. For example, device support services 230 may include spatial reconstruction services 245, which may operate to generate three-dimensional maps of physical spaces based on locally provided depth data, as described further herein. This may include support for a scanning app which may predominantly be operated on a local device. Device support services 230 may further include spatial anchor services 250, which may enable users to designate three-dimensional coordinate locations for networked devices and passive objects within a three-dimensional reconstruction.

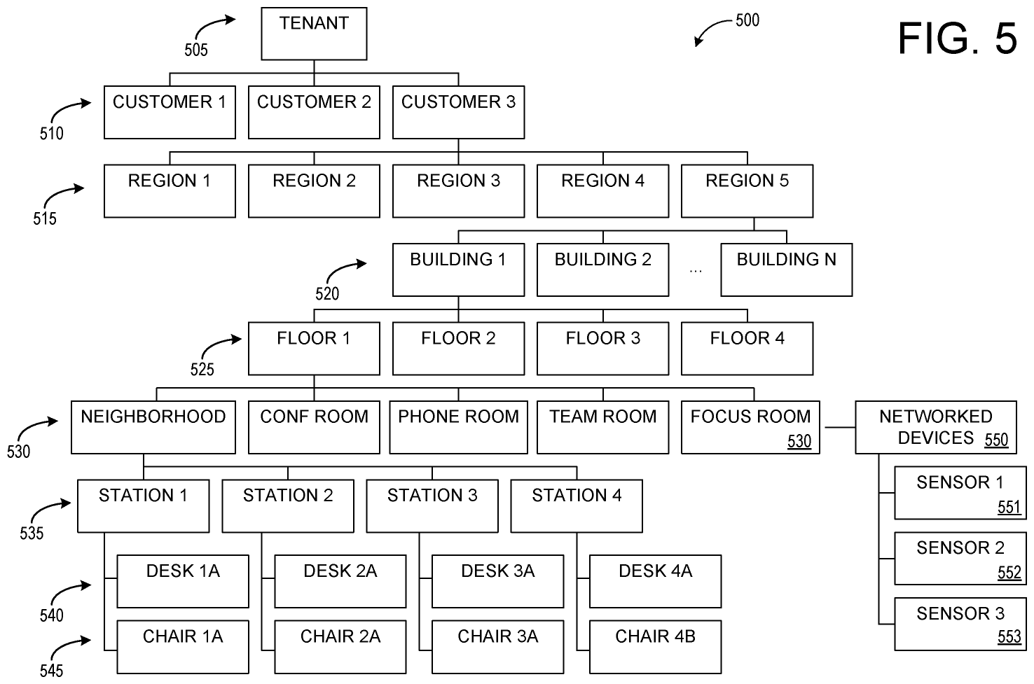

Device support services 230 may further include cognitive services 255, which may, for example, enable object detection and image classification using neural networks. Additionally, device support services 230 may include ontology graphing services 260, described further herein and with regard to FIG. 5.

Digital twins services 235 may parse and distribute data to cold analytics 265, hot analytics 270, and warm analytics 275. Cold analytics 265 may enable users to finds insights over historical data. Hot analytics 270 may enable real-time monitoring of networked devices 210. Warm analytics 275 may combine aspects of both cold analytics 265 and hot analytics 270, enabling time-series data storage and analytics.

Digital twins services 235, cold analytics 265, hot analytics 270, and warm analytics 275 may then parse and distribute data to a plurality of downstream applications 280, including, but not limited to device management services 285 and business integration services 290.

Currently, to develop an IoT solution for a connected building, a developer first sources and curates a model of the building, such as by using Building Information Modeling (BIM) software. Next, the developer provisions a digital twin that can represent the relationship between the spaces, devices, and people throughout their building, campus, or portfolio. Ultimately, this groundwork then serves as the foundation for a visual experience for users such as occupants and facility managers.

However, the creation and maintenance of a digital twin may present numerous issues for customers, including expense. For example, many customers do not have accurate BIM files for a building, relying on unstructured BIM files, PDFs, spreadsheets, or less accurate data such as hand-drawn plots. This may be particularly true for older buildings being retrofitted. Instead, floor plans may be recreated, often using hand-collected data. Even if customers do indeed have floorplans, most don't have three-dimensional data, and many do not have dimensionally-accurate floorplans.

Even if accurate maps are generated, an accurate inventory of the assets, objects, and networked sensors in a space may be difficult to create, maintain, and update. A common solution to inventory passive objects is to update a spreadsheet on a tablet by manually inspecting furniture and assets, then recording that information into the digital twin. The customer needs to manually define a digital twin ontology and then call the right APIs to put the objects, maps, and sensors in the right node in the ontology. Partners and customers are often left to create their own advanced scripts or to manually calling provided APIs by hand.

Further, when it comes to visualizing maps with objects and IoT sensors in them, partners and customers must know where each object and sensor should be placed in the map and then clean up these populated maps so that they are consumable by building operators, managers, and occupants. This process is predominantly done manually. Tools may be used to facilitate this process with a graphical user interface, but the steps still may be performed manually at the cost of reduced placement accuracy. As such, developers may have difficulties creating digital twins of physical environments, and facility managers may struggle to keep this data up to date.

Accordingly, examples are disclosed herein that use depth cameras to scan a physical space, use the depth data to build a three-dimensional map of the environment (from which two-dimensional maps, CAD files, BIM files, etc.) can be generated), identify passive objects in the map, and recognize and localize networked sensors. Customers may define the digital twin ontology manually, or automatically based on signals from the environment, to provision a rich digital twin of a space. The disclosed examples may save both time and money on the creation of digital twins. Further, having a precise model of an environment may enable additional understanding that feeds into AI technologies. The algorithms that exist within AI technologies may be leveraged and connected to the digital twins systems and may connect to specific networked devices that are live-streaming data into the cloud.

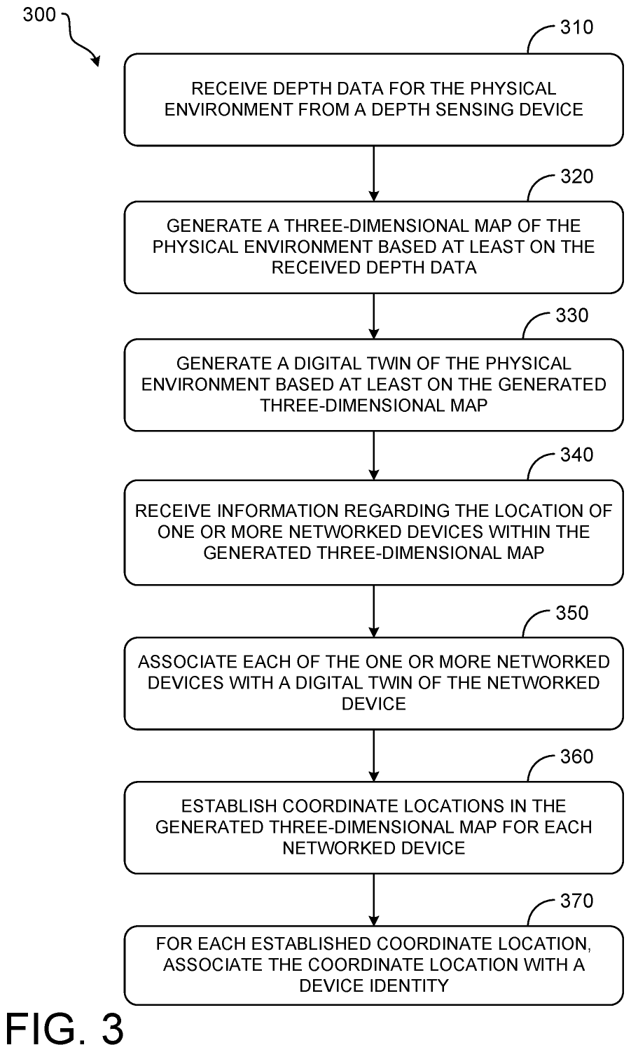

FIG. 3 shows an example method for generating a digital twin of a physical environment. As an example, the digital twin may be generated based on data received from one or more depth sensors, such as a depth sensor included in a head-mounted display. The depth sensor may be communicatively coupled to one or more network and/or cloud services, such as the services described with regard to FIG. 2.

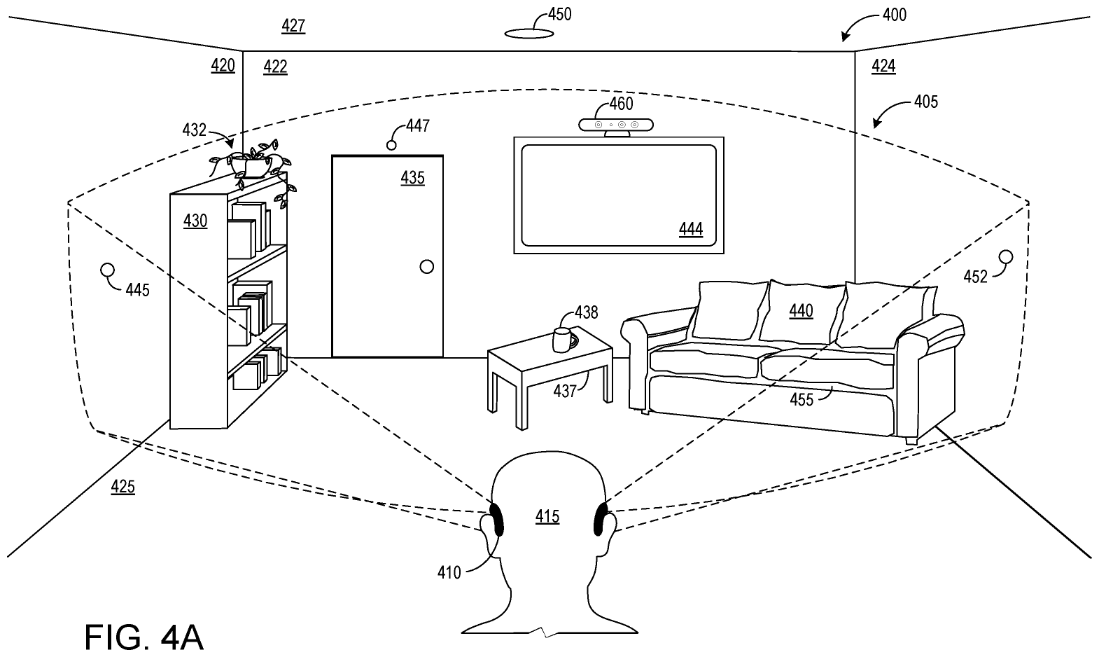

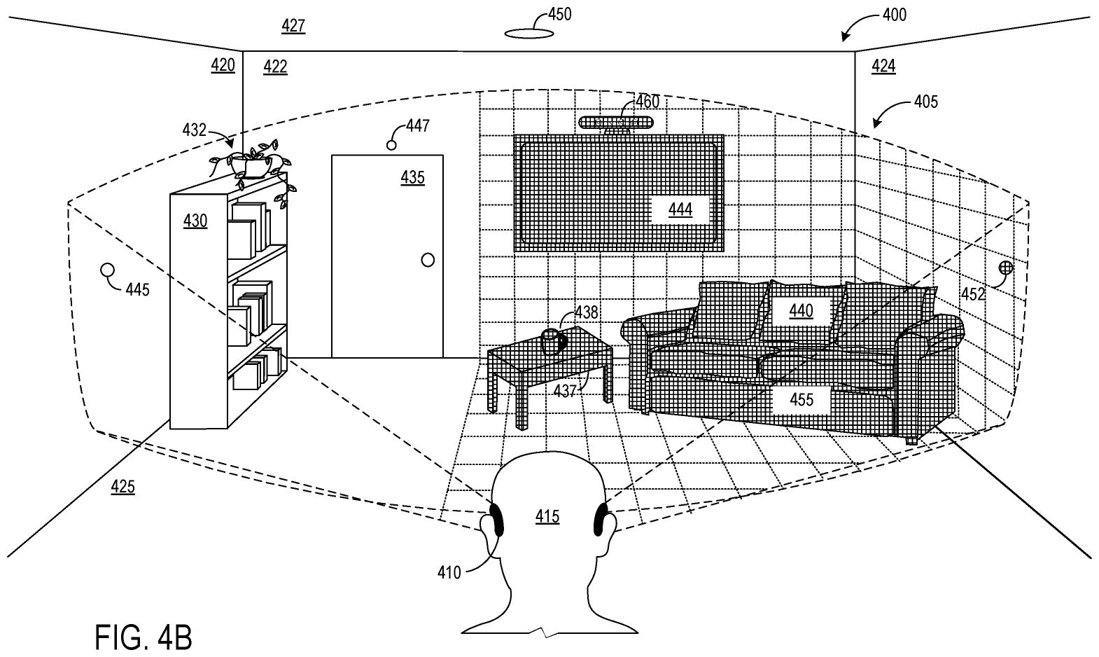

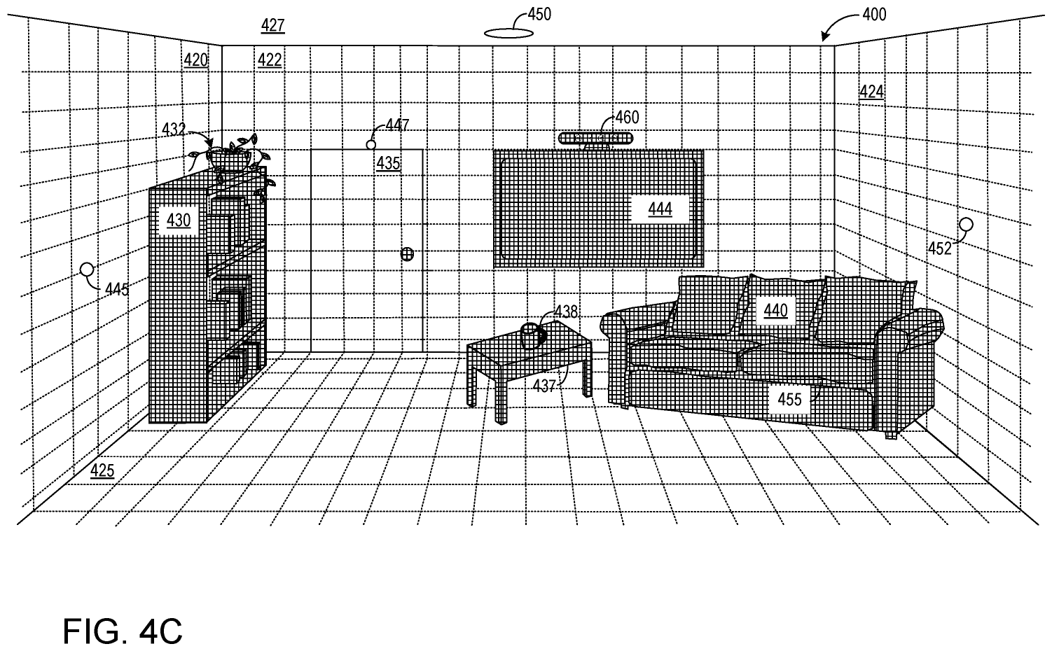

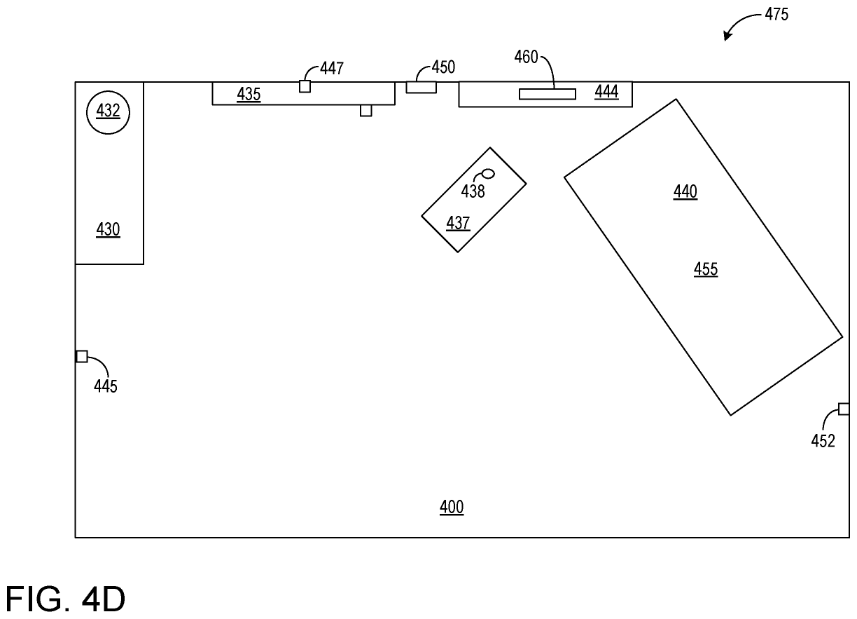

At 310, method 300 includes receiving depth data for the physical environment from a depth sensing device. In some examples, the depth sensing device is included in a head-mounted display device worn by a user. For example, FIG. 4A shows an example physical environment 400 through the FOV 405 of a head-mounted display 410 worn by user 415. Depth data also may be received from standalone depth cameras and/or depth sensing devices, depth sensing devices connected to mobile robots, drones, etc. Physical environment 400 is shown in the form of a room, but may take the form of any interior or exterior environment that can be represented by a spatially, textual graph having nodes at which sensors and other objects may be attached. Non-limiting examples of physical environments include multi-room and/or multi-floor buildings, such as office buildings, academic buildings, warehouses, living spaces, commercial buildings, greenhouses, churches, outdoor spaces (e.g., agricultural), multi-building campuses, multi-campus entities, etc.

Physical environment 400 includes numerous passive objects and numerous networked sensors. For example, passive objects may include walls 420, 422, and 424, floor 425, ceiling 427, bookshelf 430, plant 432, door 435, coffee table 437, coffee cup 438, couch 440, and display screen 444. Networked sensors may include thermostat 445, motion sensor 447, ambient light sensor 450, humidity sensor 452, and couch occupancy sensor 455. Additionally, display screen 444 may be communicatively coupled to input device 460, which may include one or more depth cameras, one or more RGB cameras, one or more microphones, and/or other sensors that may be networked.

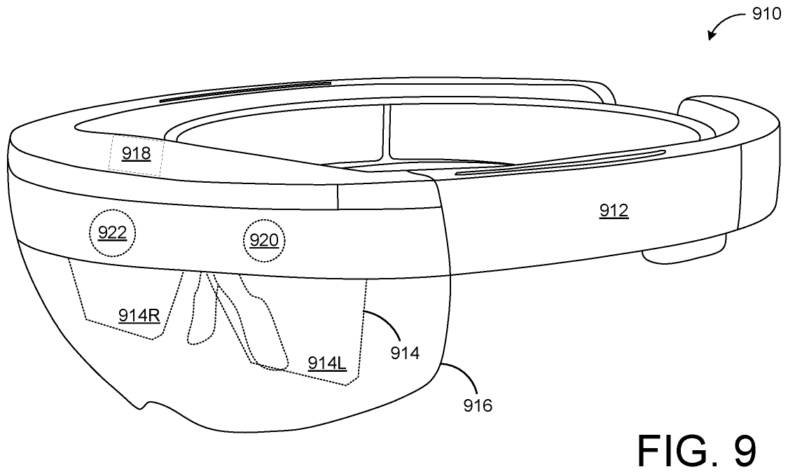

User 415 may walk around physical environment 400, collecting depth information from a variety of angles and vantage points. Head-mounted display 410 may include a position sensor system, enabling individual depth images to be built into a three-dimensional model of physical environment 400. The position sensor system may also track the position of the optical sensor system in relation to a three-dimensional model of physical environment 400. Example position sensors are described further herein and with regard to FIG. 9, and may include accelerometers, gyroscopes, magnetometers, image sensors, etc.

In addition to or as an alternative to a depth sensing device included in a head-mounted display, additional depth data may be captured with one or more depth cameras, security cameras, etc., in the environment, once sufficient location data for the physical environment is captured to place cameras in a three-dimensional map. Once located in the three-dimensional map, the depth sensors may obtain depth data for the physical environment from fixed coordinate positions, though the angle of the cameras may change during the process of scanning the physical environment. For example, a depth camera included in input device 460 may scan physical environment 400 from a different angle than is attainable by head-mounted display 410, generating a richer depth data set for the environment.

Spatial mapping of an environment may be based on measurements received from depth sensing hardware (e.g. LIDAR or depth cameras), or from a digital structure generated via multi-view stereo algorithms using traditional video or photo camera input. When using a depth camera, a series of depth maps are generated that represent a distance per pixel between the depth camera and a surface within the environment. Depth maps may be converted to a three-dimensional point cloud using camera calibration. Multiple three-dimensional point clouds may then be fused into a three-dimensional map or digital representation of the environment.

A depth camera may take between 1 and 30 depth images of an environment each second in some examples, though higher or lower frame rates may also be used. When using a depth camera associated with a head-mounted display (HMD), Simultaneous Localization and Mapping (SLAM) methods may be used to calculate a 6 Degrees of Freedom (6DoF) pose of the depth camera within the environment for each image. This allows each of the depth images to be mapped to a common coordinate system, and enables an assumption that a position within the common coordinate system is accurately known for each input depth image.

However, in some examples, head-mounted displays may not operate using one global coordinate system. Instead, the global coordinate system may be split into smaller, local coordinate systems, also called anchors (or key frames). In some examples, one local coordinate system is created at a position within the environment. When the user migrates from that position, another local coordinate system is created that may be spaced from the first local coordinate system (e.g. by 1-2 meters in some examples). The local coordinate systems may be connected via one or more transformations. The transformations may become more accurate and/or precise with additional data/iterations, improving the global coordinate system and making it more stable. Both the local coordinate systems and global coordinate system may be world-locked, and may also be edited and improved over time. Neighboring local coordinate systems may overlap, and thus may share some features. As such, the relative positions of two local coordinate systems may be determined using three-dimensional geometry based on the common features. The depth images for the local coordinate systems may then be fused into a global volume with a global coordinate system, and a surface mesh for the environment extracted from the global volume. In some examples, multiple depth cameras may communicate with each other, sharing anchors and thus collecting data on a shared coordinate system.

The head-mounted display may operate one or more scanning applications to aid in generating and labelling three-dimensional mapping data. A user wearing the head-mounted display may go into a building or other physical environment and launch a scanning app. The user may manually input the venue (e.g., Building 1, floor 1, room 1) or the head-mounted display may recognize the venue based on one or more labels or pieces of smart context information. For example, as the user enters a new room, like a conference room, for example, the head-mounted display may automatically identify the room if there's a real-world conference room label, or the user can manually define the new room using text or speech input, as examples.

The depth cameras and position sensors capture raw data that will later build a high-quality three-dimensional map, tracking map, and identify objects in the map. In some examples, a scanning application may provide visual feedback to a user wearing the head-mounted display device responsive to receiving depth data for the physical environment. In this way, the user can progressively image the physical environment, re-scanning or returning to portions of the physical environment where additional depth data is needed to complete the three-dimensional image of the physical environment. An example is shown in FIG. 4B. User 415 is indicated that portions of floor 425, wall 422, and wall 424 have been captured. In addition, user 415 is indicated that passive objects, such as couch 440, coffee table 437, coffee cup 427, and display screen 444 have been captured.

Returning to FIG. 3, at 320, method 300 includes generating a three-dimensional map of the physical environment based at least on the received depth data. When user 415 is done scanning physical environment 400, the user can see an overview of the space that was scanned. An example is shown in FIG. 4C. The depth data may be uploaded to a three-dimensional reconstruction service, such as reconstruction services 240. The three-dimensional reconstruction service may then send the raw data from the device to the server for full processing to create a complete map and run more advanced object detection. The three-dimensional reconstruction service may generate a three-dimensional map of the space that can also be flattened to a corresponding two-dimensional map (e.g., floorplan.) An example two-dimensional map of physical environment 400 is shown at 475 of FIG. 4D, for example.

At 330, method 300 may include generating a digital twin of the physical environment based at least on the generated three-dimensional map. For example, the physical environment may be modeled in order to provide contextual information and digital framework for objects and networked sensors within the physical environment, as well as providing context for people that inhabit the physical environment and processes that occur within the physical environment. The digital twin of the physical environment thus may be a hub for data generated at or associated with the physical environment.

At 340, method 300 includes receiving information regarding the location of one or more networked devices within the generated three-dimensional map. If the user has networked devices that need to be installed, the user can look at the networked device and can use a trained image classifier to recognize the device, or the device can communicate its identity wirelessly or from some visual property (e.g., a blinking light) to the cameras. The networked device may also have a marker like a barcode or QR code that the cameras can recognize to ID the device. In some examples, the networked device may proactively share information about itself, via short wavelength radio signals, ultrasonic communication, etc. Assuming the device has been physically installed in the correct location and is powered up and streaming data to the network, the scanning app can find that device in the digital twins service. However, the device can also be provisioned at a later time if the user is scanning the physical environment offline.

At 350, method 300 includes associating each of the one or more networked devices with a digital twin of the networked device. For example, a digital twin of a networked sensor may include a virtual instance of the networked sensor, and may be associated with data generated by the networked sensor as well as properties, communicative couplings, associated actuators, etc. If the networked devices have not previously been provisioned in the digital twins service, a new digital twin may be generated for each networked device, for example, using methodology described at 340. If a networked device already has a digital twin, this information may be retrieved and may be associated with the received location information.

At 360, method 300 includes establishing coordinate locations in the generated three-dimensional map for each networked device. The head-mounted display may estimate the three-dimensional coordinate (xyz) position of the device via raycasting. The head-mounted display may then communicate with a spatial anchor service, such as spatial anchor services 250, which may then create a spatial anchor for the xyz coordinates, and may assign a spatial anchor ID to the spatial anchor. For example, the head-mounted display may submit a series of images (two-dimensional and/or depth) to the spatial anchor service. The spatial anchor service may parse the images, extract features, and create a location from the images. Device identification may be done by a trained classifier, for example. The spatial anchor ID created may be saved in the reconstruction map so that the device can be visualized later in the three-dimensional models or two- dimensional diagrams the reconstruction service outputs. Optionally, the networked device may be provisioned into the digital twins hub with the spatial anchor ID if the user and the networked device both have network connectivity. If not, then the actual provisioning will occur at a later time.

Continuing with FIG. 3, at 370, method 300 includes, for each established coordinate location, associating the coordinate location with a device identity. For example, the established coordinate location may be associated with a spatial anchor ID, and the spatial anchor ID associated with a device identity. Once the sensor location is determined and provisioned into the digital twin, the networked sensor has an ID and a position and can be found in both the real world and the reconstructed three-dimensional model. A name-space and node within a spatial graph may be associated with the space. The three-dimensional reconstruction service may generate a spatial graph or topological representation of space that complements the physical three-dimensional map. If the networked device is already online and streaming data to the networked device hub, the networked device properties/ID/etc. are already known. The networked device may then be paired with a spatial anchor, which can be done any suitable manner, including by selecting manually from a list. In this way the digital twins for each networked device may be associated with the digital twin for the physical environment and labeled appropriately.

The head-mounted display may further detect one or more passive objects within the physical environment based on the received depth data. Each passive object detected may be associated with a coordinate location in the generated three-dimensional map, and then each passive object may be associated with an object identity. As per networked devices, passive objects may be labeled manually or automatically. For the three- dimensional model, scanned passive objects may be replaced with more accurate, pre-existing models.

Object classification may be performed using deep neural networks, for example, using existing cognitive services and/or custom vision. The user may define custom objects to look for and label by providing a custom image classifier for objects (e.g., cognitive services can be trained by providing labeled images of objects), and the reconstruction service will pass imagery to a custom image classifier. Labeling of objects may be done with RGB or flat IR. When the image classifier returns a match, the reconstruction service may note the locations and a digital twins creation app may add all objects in that space to the appropriate spatial node in the digital twin. Objects that are automatically identified may be labeled so the user can verify the objects have been correctly identified and fix any incorrect labels. A variety of labels may be applied to objects and devices, such as whether a device is hard-wired or connected via a wireless network, device firmware builds, object condition, etc.

The user may continue to scan new spaces, including objects in each space, and adding more networked devices as they move around from room to room, space to space. Each time the user enters a new space, the user can optionally define a new label in the digital twins hub. A spatial map of the building may be built that includes each room, floor, and space. Thus, in generating a digital twin for a physical environment that includes two or more defined spaces, one or more topological maps may be generated based on the generated three-dimensional maps, the topological maps indicating a relationship between the two or more defined spaces.

The digital twins service may receive identification information for each of the two or more defined spaces. The user can either capture depth data first and label later, or label while they capture. Labeling may include creating new node types (e.g., a schema) in the digital twins ontology graphing service, where each new label is a new node in the digital twins ontology. In some examples, once a node type has been created, new nodes may be assigned the same node type (e.g., a building may have multiple instances of conference rooms). The user may alternatively create the ontology first. In a commercial office building, for example, the user can create a new “building” label, and then create a “floor” label that is nested in that building. The user may then label different types of rooms in each floor, such as offices, neighborhoods, conference rooms, focus rooms, etc. Each space may be assigned a variety of labels, for example, indicating whether the room has natural light, which compass direction the room's windows are facing, etc.) The user can then begin moving around the actual floor to start scanning.

FIG. 5 shows an example of such aa topological map 500 for a multi-campus company. Map 500 is presented for the purpose of illustration, and is not intended to be limiting. A tenant 505 comprises multiple customers 510. In this example, customer 3 is shown as comprising five regions 515. Region 5 is shown as comprising a plurality of buildings 520. Building 1 of region 5 comprises four floors 525. Floor 1 is shown as including a number of different room types 530, including a neighborhood, a conference room, a phone room, a team room, and a focus room 531. The neighborhood is shown as including four stations 535, each station including a desk 540 and a chair 545.

In this example, a cluster of networked devices 550 is shown for focus room 531, including sensors 551, 552, and 553. For each networked sensor, a spatial anchor may be generated based at least on one or more images of each networked sensor and the generated three-dimensional map, as described with regard to FIG. 3. Spatial anchors may also be generated for passive objects, fixtures, non-networked devices, etc. A spatial anchor may be generated responsive to receiving user input designating a coordinate location as a spatial anchor. Each generated spatial anchor may then be sent to one or more remote devices. A node in the topological map may then be assigned to each networked device indicating the physical relationship of each network device to one or more defined spaces.

Once the reconstruction of the physical environment is complete, the digital twin may be provisioned according to the ontology defined, and all the three-dimensional models, dimensions of the space, objects in the map, IoT devices in the map will all be added to the digital twins ontology to enable downstream digital twins applications. For example, a digital twins experience may run on PCs, tablets, mobile devices and mixed reality that may show a live visualization of the digital twin with three-dimensional and two-dimensional views of the space, the objects in the map, and the networked devices in the map. A user may be able to toggle the topology and object labels (e.g. building/floor/room type etc.) on and off as a map overlay. The user may be able to view live data on the digital twin, and independent software vendors (ISVs) can build custom views for custom sensors. For example, motion sensors may be provisioned in each room, and rooms may be colored red if they are occupied or green if they are available. The user can also edit the map by moving objects around, changing the labels, and fixing up as necessary.

Once the three-dimensional reconstruction and digital twin are built for a physical environment, they may be updated or edited. For example, a user may want to re-scan some portion of a space, scan a new section of a space, or update the presence, location, etc. of objects and networked devices that have been removed, added, or moved. The user may enter the physical environment, select the already created digital twin of the physical environment, and view the digital twin in the real world to look for differences. Further, a partner can use the digital twin experiencce and scanning experience to validate that assets/objects are in the correct locations.

The user may also start scanning the physical environment again, which will then follow the same scanning procedure as before. The head-mounted display may find its position in the three-dimensional map, and then the user may rescan the physical environment and update the three-dimensional model. New depth data may be received for the physical environment, the new depth data associated with one or more coordinate locations in the generated three-dimensional map. The new depth data for the physical environment may be compared with the generated three-dimensional map of the physical environment, and an updated three-dimensional map of the physical environment may be generated. In some examples, the generated three-dimensional map of the physical environment and one or more updated three-dimensional maps of the physical environment may be used to generate playback showing changes to the physical environment over time.

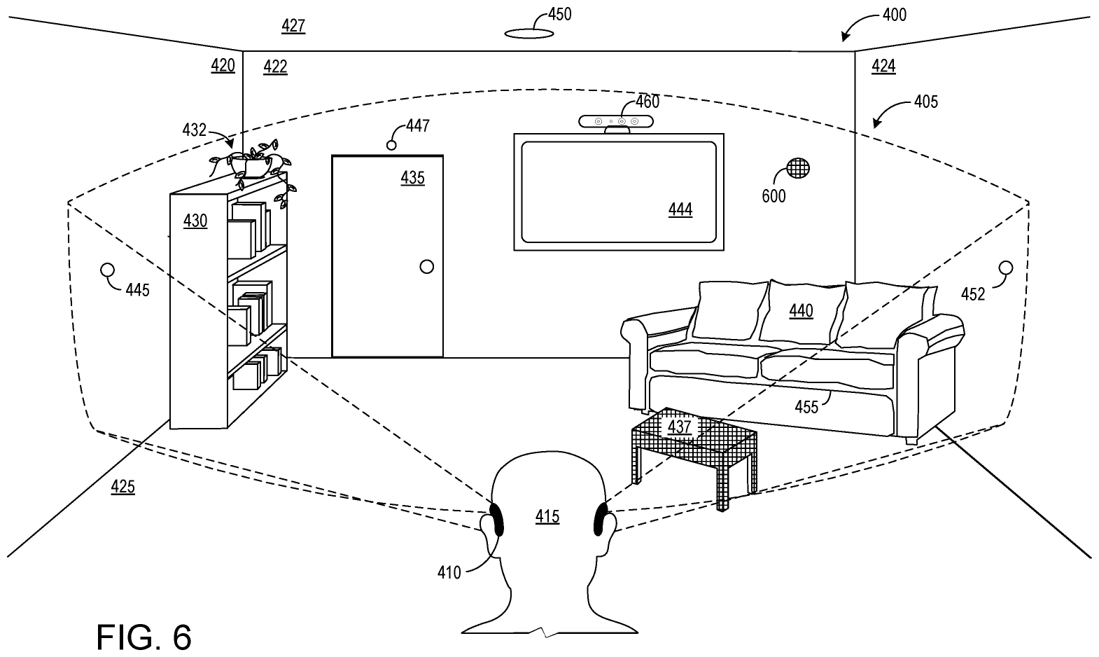

The head-mounted display may again send image data via reconstruction services to send the data to the server to update the maps, models, object labels, and networked devices in the digital twin. As an example, FIG. 6 shows an updated view of physical environment 400. In this view, coffee table 438 has moved, and coffee cup 438 has been removed. As shown, user 415 can quickly visualize this change, rescan coffee table 437, and update the three-dimensional map of physical environment 400.

To install a new sensor, such as barometer 600, the user may plug in the sensor, power the sensor on, connect the sensor to the network, and then create a new spatial anchor as described herein. The digital twin services may receive a data stream from a new networked sensor and receive image data of the new network sensor within the physical environment. A coordinate location may then be assigned in the generated three-dimensional map for the new networked device, and the coordinate location may be associated with a device identity of the new networked sensor.

If a networked device is removed or disconnected, the digital twin may automatically delete the device and associated spatial anchors. Further, if a networked device is moved, the position of the networked device in the digital twin may not be updated until the networked device is imaged at its new location and the spatial anchor service called to update the location. In some examples, RGB and/or depth cameras within an environment (e.g., input device 460) may provide image data to automatically update the location of passive objects and/or networked sensors once the digital twin is established.

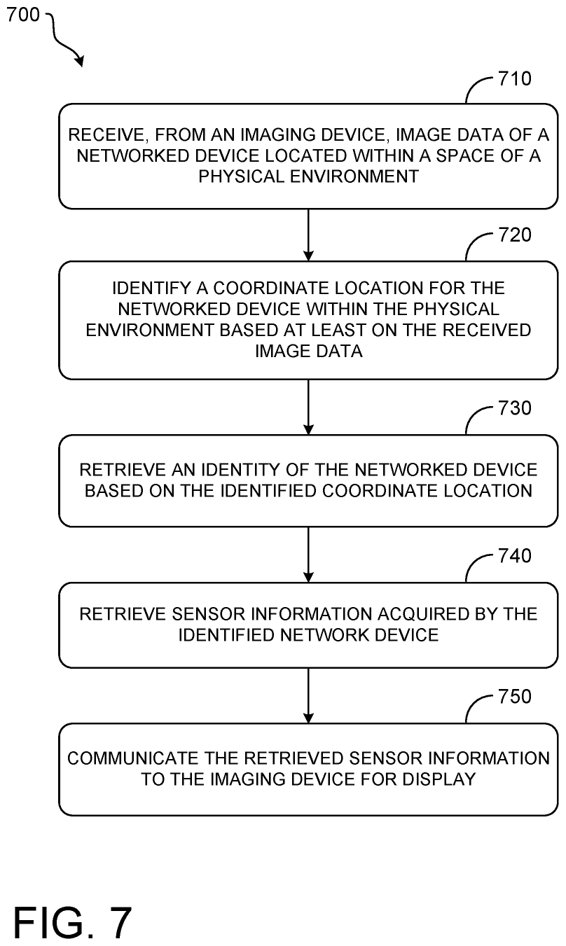

FIG. 7 shows an example method 700 for retrieving device information. Once a networked device is provisioned within a digital twin, a user may aim the imaging sensors of a head mounted display, phone, tablet, or other device having both a camera and a display at the networked device and access information about the device in mixed reality, at the position of the networked device, for example. This may help occupants, facilities managers, and building users to access information and inspect what is going on in the actual building regarding networked devices.

At 710, method 700 includes receiving, from an imaging device, image data of a networked device located within a space of a physical environment. The imaging device may be a head-mounted display device. A user may enter a physical environment wearing a head-mounted display device, which may identify the physical environment and enable the head- mounted display to access data from the digital twin for the physical environment. The imaging device may additionally or alternatively include an RGB camera. For example, once the digital twin is established, two-dimensional images may be sufficient to identify networked devices. For example, identifying characteristics of the networked device, physical environment, or surrounding objects may allow the spatial anchor service to infer a three-dimensional coordinate or device identity from a two-dimensional image, such as by comparing the two-dimensional image to the previously generated three-dimensional mesh.

At 720, method 700 includes identifying a coordinate location for the networked device within the physical environment based at least on the received image data. For example, the image data may correlate with one or more spatial anchors that have other anchors nearby, including one for a desired network device. Additionally or alternatively, GPS, short wavelength radio communication, etc. may aid in determining the coordinate location of the head-mounted display, and thus the coordinate location for the networked device.

At 730, method 700 includes retrieving an identity of the networked device based on the identified coordinate location. In some examples, the identity may be retrieved automatically based on the three-dimensional position of the networked device. Alternatively, the user may be prompted with a list of networked devices in the physical environment.

At 740, method 700 includes retrieving sensor information acquired by the identified network device. For example, the networked device may store data remotely at a cloud service. The user may choose to retrieve sensor data for a fixed period of time, for example.

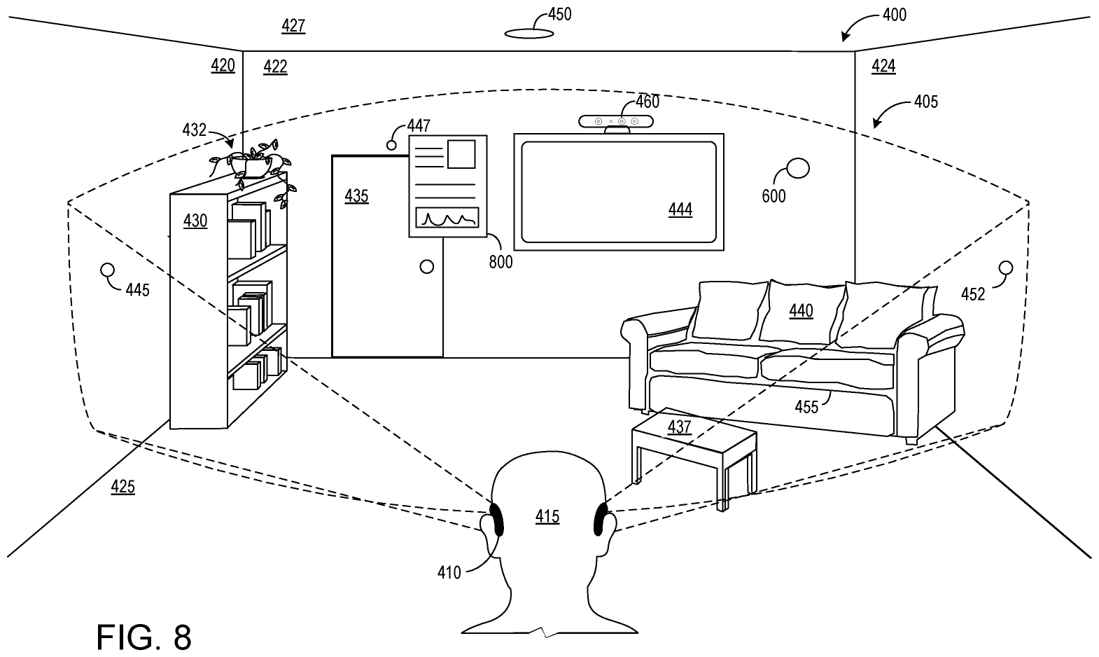

At 750, method 700 includes displaying the retrieved sensor information via a display of the imaging device. The retrieved sensor information is displayed as an augmented reality image via the display of the imaging device. An example is shown in FIG. 8. User 410 is viewing physical space 400 through head-mounted display 415, and has trained the imaging sensors of head-mounted display 415 on motion sensor 447. Sensor information 800 for motion sensor 447 is presented to user 410 via head-mounted display 415.

A user further may use a head-mounted display or other display device to remotely navigate a digital twin in a virtual reality mode, as immersive three-dimensional image data has been collected for a physical environment. A user may thus pull up information and controls for a networked device without being in the physical environment.

Further, method 700 may optionally include adjusting a parameter of the identified networked device based on input received from the imaging device. For example, a user may review the retrieved sensor information for a networked device, and then pull up a list of controls for the sensor and/or one or more associated actuators. For example, user 415 may review data for thermostat 445 and adjust the maximum temperature for physical environment 400 based on a time of day. After viewing the data for motion sensor 447, user 415 may adjust the maximum temperature for times of day when there is little to no movement in physical environment 400.

Creating and maintaining a digital twin of a physical environment may enable crosstalk between and automated control of various networked sensors in the physical environment. For example, multiple thermostats in different spaces may be monitored to view temperature gradients across the physical environment and to anticipate changes, such as when doors are left open. Compensation may then be performed across multiple actuators. The three-dimensional map of the physical environment includes knowledge about the distances between sensor and information about individual spaces, such the total volume and airmass volume (total volume minus object volume), and thus allow actuator gradients to be specified for each space. Temperature control for an individual office may be controlled based on the office occupant's preferences, entry point, habits, etc. as determined and monitored by various motion sensors, card scanners, etc.

The examples disclosed above may be implemented on any suitable imaging and display device. While primarily described with regard to head-mounted display devices, other depth and imaging sensors may be utilized, such as one or more fixed-position depth cameras and/or depth sensing devices, depth sensing devices connected to mobile robots, drones, etc. LIDAR sensors, etc, and may be augmented or substituted by RGB cameras, flat-image IR cameras, etc. that may be included in a mobile phone device, tablet device, etc.

FIG. 9 schematically illustrates an example head-mounted display device 910. The head-mounted display device 910 includes a frame 912 in the form of a band wearable around a head of the user that supports see-through display componentry positioned near the user's eyes. Head- mounted display device 910 may use augmented reality technologies to enable simultaneous viewing of virtual display imagery and a real-world background. As such, the head-mounted display device 910 may generate virtual images via see-through display 914, which includes separate right and left eye displays 914R and 914L, and which may be wholly or partially transparent. The see-through display 914 may take any suitable form, such as a waveguide or prism configured to receive a generated image and direct the image towards a wearer's eye. The see-through display 914 may include a backlight and a microdisplay, such as liquid-crystal display (LCD) or liquid crystal on silicon (LCOS) display, in combination with one or more light-emitting diodes (LEDs), laser diodes, and/or other light sources. In other examples, the see-through display 914 may utilize quantum-dot display technologies, active-matrix organic LED (OLED) technology, and/or any other suitable display technologies. It will be understood that while shown in FIG. 9 as a flat display surface with left and right eye displays, the see-through display 914 may be a single display, may be curved, or may take any other suitable form.

The head-mounted display device 910 further includes an additional see-through optical component 916, shown in FIG. 9 in the form of a see-through veil positioned between the see-through display 914 and the real-world environment as viewed by a wearer. A controller 918 is operatively coupled to the see-through optical component 916 and to other display componentry. The controller 918 includes one or more logic devices and one or more computer memory devices storing instructions executable by the logic device(s) to enact functionalities of the head-mounted display device 910. The head-mounted display device 910 may further include various other components, for example a two-dimensional image camera 920 (e.g. a visible light camera and/or infrared camera) and a depth imaging device 922, as well as other components that are not shown, including but not limited to speakers, microphones, accelerometers, gyroscopes, magnetometers, temperature sensors, touch sensors, biometric sensors, other image sensors, eye-gaze detection systems, energy-storage components (e.g. battery), a communication facility, a GPS receiver, etc.

Depth imaging device 922 may include an infrared light-based depth camera configured to acquire video of a scene including one or more human subjects. The video may include a time-resolved sequence of images of spatial resolution and frame rate suitable for the purposes set forth herein. The depth imaging device 922 and/or a cooperating computing system (e.g., controller 918) may be configured to process the acquired video to identify one or more objects within the operating environment, one or more postures and/or gestures of the user wearing head-mounted display device 910, one or more postures and/or gestures of other users within the operating environment, etc.

The nature and number of cameras may differ in various depth imaging devices consistent with the scope of this disclosure. In general, one or more cameras may be configured to provide video from which a time-resolved sequence of three-dimensional depth maps is obtained via downstream processing. As used herein, the term “depth map” refers to an array of pixels registered to corresponding regions of an imaged scene, with a depth value of each pixel indicating the distance between the camera and the surface imaged by that pixel. In various implementations, depth imaging device 922 may include right and left stereoscopic cameras, a “structured light” depth camera, or a “time-of-flight” (TOF) depth camera.

In some embodiments, the methods and processes described herein may be tied to a computing system of one or more computing devices. In particular, such methods and processes may be implemented as a computer-application program or service, an application-programming interface (API), a library, and/or other computer-program product.

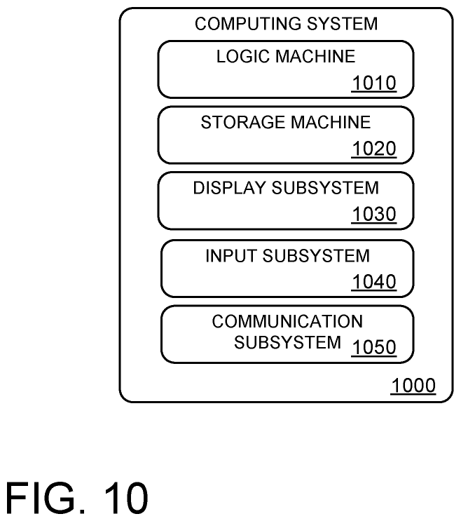

FIG. 10 schematically shows a non-limiting embodiment of a computing system 1000 that can enact one or more of the methods and processes described above. Computing system 1000 is shown in simplified form. Computing system 1000 may take the form of one or more personal computers, server computers, tablet computers, home-entertainment computers, network computing devices, gaming devices, mobile computing devices, mobile communication devices (e.g., smart phone), and/or other computing devices.

Computing system 1000 includes a logic machine 1010 and a storage machine 1020. Computing system 1000 may optionally include a display subsystem 1030, input subsystem 1040, communication subsystem 1050, and/or other components not shown in FIG. 10.

Logic machine 1010 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 1020 includes one or more physical devices configured to hold instructions executable by the logic machine to implement the methods and processes described herein. When such methods and processes are implemented, the state of storage machine 1020 may be transformed—e.g., to hold different data.

Storage machine 1020 may include removable and/or built-in devices. Storage machine 1020 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 1020 may include volatile, nonvolatile, dynamic, static, read/write, read-only, random-access, sequential-access, location-addressable, file-addressable, and/or content-addressable devices.

It will be appreciated that storage machine 1020 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 1010 and storage machine 1020 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 1000 implemented to perform a particular function. In some cases, a module, program, or engine may be instantiated via logic machine 1010 executing instructions held by storage machine 1020. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service”, as used herein, is an application program executable across multiple user sessions. A service may be available to one or more system components, programs, and/or other services. In some implementations, a service may run on one or more server-computing devices.

When included, display subsystem 1030 may be used to present a visual representation of data held by storage machine 1020. This visual representation may take the form of a graphical user interface (GUI). As the herein described methods and processes change the data held by the storage machine, and thus transform the state of the storage machine, the state of display subsystem 1030 may likewise be transformed to visually represent changes in the underlying data. Display subsystem 1030 may include one or more display devices utilizing virtually any type of technology. Such display devices may be combined with logic machine 1010 and/or storage machine 1020 in a shared enclosure, or such display devices may be peripheral display devices.

When included, input subsystem 1040 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1050 may be configured to communicatively couple computing system 1000 with one or more other computing devices. Communication subsystem 1050 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 1050 to send and/or receive messages to and/or from other devices via a network such as the Internet.

In one example, a method for generating a digital twin of a physical environment, comprises receiving depth data for the physical environment from a depth sensing device; generating a three-dimensional map of the physical environment based at least on the received depth data; generating a digital twin of the physical environment based at least on the generated three-dimensional map; receiving information regarding a location of one or more networked devices within the generated three-dimensional map; establishing coordinate locations in the generated three-dimensional map for each networked device; and, for each established coordinate location, associating the coordinate location with a device identity. In such an example, or any other example, the depth sensing device may additionally or alternatively be included in a head-mounted display device. In any of the preceding examples, or any other example, the method may additionally or alternatively comprise detecting one or more passive objects within the physical environment based on the received depth data. In any of the preceding examples, or any other example, the method may additionally or alternatively comprise associating each passive object detected with a coordinate location in the generated three-dimensional map; and associating each passive object with an object identity. In any of the preceding examples, or any other example, the method may additionally or alternatively comprise generating one or more two-dimensional maps corresponding to a floorplan of the generated three-dimensional map. In any of the preceding examples, or any other example, the physical environment may additionally or alternatively include two or more defined spaces, and the method may additionally or alternatively comprise generating one or more topological maps based on the generated three-dimensional maps, the topological maps indicating a relationship between the two or more defined spaces. In any of the preceding examples, or any other example, the method may additionally or alternatively comprise receiving identification information for each of the two or more defined spaces. In any of the preceding examples, or any other example, establishing coordinate locations in the generated three-dimensional map for each networked sensor may additionally or alternatively comprise generating a spatial anchor for each networked sensor based at least on one or more images of each networked sensor and the generated three-dimensional map. In any of the preceding examples, or any other example, generating a spatial anchor may additionally or alternatively comprise generating the spatial anchor responsive to receiving user input designating a coordinate location as a spatial anchor. In any of the preceding examples, or any other example, the method may additionally or alternatively comprise sending each generated spatial anchor to one or more remote devices. In any of the preceding examples, or any other example, the method may additionally or alternatively comprise assigning a node in the topological map to each networked device indicating a physical relationship of each network device to one or more defined spaces. In any of the preceding examples, or any other example, the method may additionally or alternatively comprise receiving new depth data for the physical environment, the new depth data associated with one or more coordinate locations in the generated three-dimensional map; comparing the new depth data for the physical environment with the generated three-dimensional map of the physical environment; and generating an updated three-dimensional map of the physical environment. In any of the preceding examples, or any other example, the method may additionally or alternatively comprise receiving a data stream from a new networked sensor; receiving image data of the new networked sensor within the physical environment; assigning a coordinate location in the generated three-dimensional map for the new networked sensor; and associating the coordinate location with a device identity of the new networked sensor.

In another example, a computing system comprises a storage machine holding instructions executable by a logic machine to: receive, from an imaging device, image data of a networked device located within a space of a physical environment; identify a coordinate location for the networked device within the physical environment based at least on the received image data; retrieve an identity of the networked device based on the identified coordinate location; retrieve sensor information acquired by the identified networked device; and communicate the retrieved sensor information to the imaging device for display. In such an example, or any other example, the imaging device may additionally or alternatively be a head-mounted display device. In any of the preceding examples, or any other example, the imaging device may additionally or alternatively include an RGB camera. In any of the preceding examples, or any other example, the storage machine may additionally or alternatively hold instructions executable by the logic machine to: adjust a parameter of the identified networked device based on input received from the imaging device. In any of the preceding examples, or any other example, the retrieved sensor information may additionally or alternatively be displayed as an augmented reality image via the display of the imaging device.

In yet another example, a computing system, comprises a storage machine holding instructions executable by a logic machine to: receive depth data for a physical environment from a depth sensing device; generate a three-dimensional map of the physical environment based at least on the received depth data; generate a digital twin of the physical environment based at least on the generated three-dimensional map; receive information regarding a location of one or more networked devices within the generated three-dimensional map; establish coordinate locations in the generated three-dimensional map for each networked device; and associate the established coordinate location with a device identity for each networked device. In such an example, or any other example, the storage machine may additionally or alternatively hold instructions executable by the logic machine to: generate a spatial anchor for each networked sensor based at least on one or more images of each networked sensor and the generated three-dimensional map; send each generated spatial anchor to one or more remote devices; and assign a node in an topological map to each networked device indicating a physical relationship of each network device to one or more defined spaces.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above- described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for generating a digital twin of a physical environment, comprising:
receiving depth data for the physical environment from a depth sensing device;
generating a three-dimensional map of the physical environment based at least on the received depth data;
generating a digital twin of the physical environment based at least on the generated three-dimensional map;
receiving information regarding a location of one or more networked devices within the generated three-dimensional map;
associating each of the one or more networked devices with a digital twin of the networked device;
establishing coordinate locations in the generated three-dimensional map for each networked device; and
for each established coordinate location, associating the coordinate location with a device identity.

2. The method of claim 1, wherein the depth sensing device is included in a display device.

3. The method of claim 1, further comprising:
detecting one or more passive objects within the physical environment based on the received depth data.

4. The method of claim 3, further comprising:
associating each passive object detected with a coordinate location in the generated three-dimensional map; and
associating each passive object with an object identity.

5. The method of claim 1, further comprising:
generating one or more two-dimensional maps corresponding to a floorplan of the generated three-dimensional map.

6. The method of claim 1, wherein the physical environment includes two or more defined spaces, the method further comprising:
generating one or more topological maps based on the generated three-dimensional maps, the topological maps indicating a relationship between the two or more defined spaces.

7. The method of claim 6, further comprising receiving identification information for each of the two or more defined spaces.

8. The method of claim 6, wherein establishing coordinate locations in the generated three-dimensional map for each networked sensor further comprises:
generating a spatial anchor for each networked sensor based at least on one or more images of each networked sensor and the generated three- dimensional map.

9. The method of claim 8, wherein generating a spatial anchor further comprises:
generating the spatial anchor responsive to receiving user input designating a coordinate location as a spatial anchor.

10. The method of claim 8, further comprising:
sending each generated spatial anchor to one or more remote devices.

11. The method of claim 8, further comprising:
assigning a node in the topological map to each networked device indicating a physical relationship of each network device to one or more defined spaces.

12. The method of claim 1, further comprising:
receiving new depth data for the physical environment, the new depth data associated with one or more coordinate locations in the generated three-dimensional map;
comparing the new depth data for the physical environment with the generated three-dimensional map of the physical environment; and
generating an updated three-dimensional map of the physical environment.

13. The method of claim 1, further comprising:
receiving a data stream from a new networked sensor;
receiving image data of the new networked sensor within the physical environment;
assigning a coordinate location in the generated three-dimensional map for the new networked sensor; and
associating the coordinate location with a device identity of the new networked sensor.

14. A computing system, comprising:
a storage machine holding instructions executable by a logic machine to:
receive, from an imaging device, image data of a networked device located within a space of a physical environment;
identify a coordinate location for the networked device within the physical environment based at least on the received image data;
retrieve an identity of the networked device based on the identified coordinate location;
retrieve sensor information acquired by the identified networked device; and
communicate the retrieved sensor information for display.

15. The computing system of claim 14, wherein the imaging device is a head-mounted display device.

16. The computing system of claim 14, wherein the imaging device includes an RGB camera.

17. The computing system of claim 14, wherein the storage machine further holds instructions executable by the logic machine to:
adjust a parameter of the identified networked device based on input received from the imaging device.

18. The computing system of claim 14, wherein the retrieved sensor information is displayed as an augmented reality image via the display of the imaging device.

19. A computing system, comprising:
a storage machine holding instructions executable by a logic machine to:
receive depth data for a physical environment from a depth sensing device;
generate a three-dimensional map of the physical environment based at least on the received depth data;
generate a digital twin of the physical environment based at least on the generated three-dimensional map;
receive information regarding a location of one or more networked devices within the generated three-dimensional map;
associate each of the one or more networked devices with a digital twin of the networked device;
establish coordinate locations in the generated three-dimensional map for each networked device; and
associate the established coordinate location with a device identity for each networked device.

20. The computing system of claim 19, wherein the storage machine further holds instructions executable by the logic machine to:
generate a spatial anchor for each networked sensor based at least on one or more images of each networked sensor and the generated three- dimensional map;
send each generated spatial anchor to one or more remote devices; and
assign a node in a topological map to each networked device indicating a physical relationship of each network device to one or more defined spaces.
